(19) United States
(12) Patent Application Publication
(10) Pub. No.: US 2015/0134462 A1
(43) Pub. Date: May 14, 2015

(54) DYNAMIC BID PRICE SELECTION

(71) Applicant: Turn Inc., Redwood City, CA (US)

(72) Inventors: Ali Jalali, San Mateo, CA (US); Ali Dasdan, San Jose, CA (US)

(73) Assignee: Turn Inc., Rewood City, CA (US)

(21) Appl. No.: 14/075,345

(22) Filed: Nov. 8, 2013

(51) Int. Cl. G06Q 30/02

(52) U.S. Cl. CPC G06Q 30/0275
USPC 705/14.71

(57) ABSTRACT

Techniques and mechanisms described herein facilitate the dynamic selection of bid price. According to various embodiments, a base bid price may be determined for an advertising opportunity bid request received at a communications interface during a designated time period. A designated bid price may be for the advertising opportunity bid request. The designated bid price may be determined at least in part by applying a bid multiplier value to the base bid price. The bid multiplier value may reflect a target pacing rate associated with the designated time period. A bid placement message may be transmitted via the communications interface. The bid placement message may identify the advertising opportunity bid request and the designated bid price.

### TECHNICAL FIELD

The present disclosure relates generally to efficient resource utilization and more specifically to the efficient pacing of budgets for online advertising campaigns.

### DESCRIPTION OF RELATED ART

In online advertising, internet users are presented with advertisements as they browse the internet using a web browser. Online advertising is an efficient way for advertisers to convey advertising information to potential purchasers of goods and services. It is also an efficient tool for non-profit/political organizations to increase the awareness in a target group of people. The presentation of an advertisement to a single internet user is referred to as an ad impression.

Billions of display ad impressions are purchased on a daily basis through public auctions hosted by real time bidding (RTB) exchanges. In many instances, a decision by an advertiser regarding whether to submit a bid for a selected RTB ad request is made in milliseconds. Advertisers often try to buy a set of ad impressions to reach as many targeted users as possible given one or more budget restrictions. Advertisers may seek an advertiser-specific action from advertisement viewers. For instance, an advertiser may seek to have an advertisement viewer purchase a product, fill out a form, sign up for e-mails, and/or perform some other type of action. An action desired by the advertiser may also be referred to as a conversion.

Advertisers often prefer to spend their budget smoothly over the time in order to reach a wider range of audience accessible throughout a day and have a sustainable impact. However, the conversions may occur relatively rarely and the occurrence feedback may be delayed. Thus, a tradeoff exists between achieving budget and performance goals.

### SUMMARY

The following presents a simplified summary of the disclosure in order to provide a basic understanding of certain embodiments of the invention. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

In general, certain embodiments of the present invention provide mechanisms for dynamic bid price selection. According to various embodiments, a base bid price may be determined for an advertising opportunity bid request received at a communications interface during a designated time period. A designated bid price may be for the advertising opportunity bid request. The designated bid price may be determined at least in part by applying a bid multiplier value to the base bid price. The bid multiplier value may reflect a target pacing rate associated with the designated time period. A bid placement message may be transmitted via the communications interface. The bid placement message may identify the advertising opportunity bid request and the designated bid price.

In some embodiments, the bid multiplier value may be determined by comparing the target pacing rate to a critical pacing rate range. For example, the bid multiplier value may be less than one when it is determined that the target pacing rate is below the critical pacing rate range.

In some embodiments, the bid multiplier value may be determined based on a target bid value ratio. The target bid value ratio may identify a ratio of paid bid value to submitted bid value. The target bid value ratio may be determined based on bid request metric values for past advertising opportunity bid requests. For example, the bid multiplier value may be greater than one when it is determined that the target pacing rate is above the critical pacing rate range.

In some implementations, the bid multiplier value may be determined at least in part based on one or more of an estimated average bid price for advertising opportunity bid requests received during the designated time period, a bid price cap for bids submitted during the designated time period, the target pacing rate, and the critical pacing rate range.

According to various embodiments, a representation of a distribution of bid request metric values may be determined for past advertising opportunity bid requests. The representation may be determined based on a bucketization of the bid request metric values. Each of the bid request metric values may be a paid value for a submitted bid for a past advertising opportunity bid request or a ratio of a paid value to a submitted value for a past advertising opportunity bid request.

According to various embodiments, the base bid price may be determined by multiplying an estimated performance metric for the advertising opportunity bid request by a target performance goal for an advertising campaign. The estimated performance metric may be an action rate or a click through rate.

In some implementations, the designated bid price may be determined by multiplying the base bid price by the bid multiplier value. The target pacing rate may identify a desired proportion of purchased advertising opportunity bid requests to received advertising opportunity bid requests during the designated time period.

### BRIEF DESCRIPTION OF THE DRAWINGS

The disclosure may best be understood by reference to the following description taken in conjunction with the accompanying drawings, which illustrate particular embodiments of the present invention.

FIGS. 1A-E illustrates graphs of budget pacing schemes, presented in accordance with one or more embodiments.

FIG. 2 illustrates an example of a budget pacing determination method, performed in accordance with one or more embodiments.

FIG. 3 illustrates an example of a target budget determination method, performed in accordance with one or more embodiments.

FIG. 4 illustrates an example of a server, configured in accordance with one or more embodiments.

FIG. 5 illustrates an example of a method for determining an advertising opportunity bid multiplier.

FIG. 6 illustrates a method for determining a bid price multiplier, performed in accordance with one or more embodiments.

FIG. 7 illustrates a method for determining a bid quality multiplier, performed in accordance with one or more embodiments.

FIGS. 8 and 9 illustrate graphs of request distributions, presented in accordance with one or more embodiments.

FIG. 10 illustrates an example of a bid price determination method, performed in accordance with one or more embodiments.

### DESCRIPTION OF PARTICULAR EMBODIMENTS

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques and mechanisms of the present invention will be described in the context of particular techniques and mechanisms related to advertising campaigns. However, it should be noted that the techniques and mechanisms of the present invention apply to a variety of different computing techniques and mechanisms. In the following description, numerous specific details are set forth in order to provide a thorough understanding of the present invention. Particular example embodiments of the present invention may be implemented without some or all of these specific details. In other instances, well known process operations have not been described in detail so as not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present invention unless otherwise noted. Furthermore, the techniques and mechanisms of the present invention will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

### Overview

According to various embodiments, techniques and mechanisms described herein facilitate dynamic bid price selection. Bids may be placed in the context of an efficient budget pacing scheme, which refers to the rate at which a budget is spent over time. When executing an online advertising campaign, an advertiser or an agent of an advertiser spends an advertising budget by bidding on advertising requests provided by a real time bidding (RTB) exchange. The advertiser may prefer that the budget be used to purchase high quality impressions. At the same time, the advertiser may prefer that the budget be spent relatively smoothly over a period of time. Techniques described herein may facilitate the dynamic determination of bid prices for advertising opportunity bid requests. One or more bid multipliers may be determined for an advertising campaign. Then, a base bid price may be determined for an advertising opportunity bid request received in the context of executing an advertising campaign. One of the bid multipliers may be applied to the base bid price to determine the bid price.

### EXAMPLE EMBODIMENTS

In recent years, the amount of ad impressions sold through real time bidding (RTB) exchanges has experienced a tremendous growth. RTB exchanges provide a technology for advertisers to algorithmically place a bid on any individual impression through a public auction. This functionality allows advertisers to buy inventory in a cost effective manner and to serve ads to the right person in the right context at the right time. However, in order to realize such functionality, advertisers need to intelligently evaluate each impression in real time or near real time. Demand-side platforms (DSPs) provide real time bid optimization techniques to help advertisers determine a bid value for each ad request very quickly. For instance, a DSP may determine a bid value in milliseconds for close to a million bids per second.

In order to use the services of a DSP, an advertiser may specify one or more parameters for an advertising campaign. The advertising campaign may include features such as a target audience and one or more budget restrictions. A budget restriction may designate an amount of money that the DSP may and/or should spend on the purchase of advertising impressions during the execution of the advertising campaign. For instance, an advertising campaign may be associated with a daily budget, a weekly budget, or any other type of budget restriction.

In order to meet budget restrictions associated with an advertising campaign, a DSP may take a budget as input and calculate a serving schedule for the campaign. Based on the serving schedule, the ad serving system can attempt to spread out impressions served for a campaign to avoid spending the budget all at once. For instance, the system may attempt to spend a daily budget for a campaign uniformly over the course of a day. However, such a strategy ignores differences in internet traffic and advertising impression performance metrics. For instance, the traffic profile distribution and past performance metrics may be such that advertising impressions during one part of the day may be more valuable than advertising impressions during another part of the day.

According to various embodiments, techniques and mechanisms described herein facilitate smooth budget pacing that takes into account various types of performance and delivery information. A real time bid optimization procedure attempts to meet or maximize one or more campaign performance goals under one or more delivery constraints within the budget schedule.

According to various embodiments, a performance goal can be specified by designating a performance metric such as cost-per-click (CPC), cost-per-action (CPA), click-through-rate (CTR), or action-rate (AR). In general, a lower CPC or CPA is more desirable, while a higher CTR or AR is more desirable. A performance goal may include a target level for a metric or may indicate that the metric is to be maximized or minimized, whichever is appropriate.

According to various embodiments, a smooth budget delivery constraint may be used to prevent the campaign from finishing the budget prematurely or avoiding a bursty spending rate. For instance, a smooth budget delivery constraint may be expressed as not buying more than a set fraction of the impressions of interest before a set time. Such a constraint may help advertisers to have sustainable influence with their ads, to avoid pushing large amount of ads in peak traffic (while performance may be degraded), and/or to explore a broader range of audience.

Performance of real time bid optimization in a RTB environment can be challenging for any or all of various reasons. For example, click and conversion events can be very rare for non-search advertisement. Therefore, the variance when estimating past performance metrics can be large.

As another example, the decision as to whether to place a bid and how to evaluate the bid price may need to be performed for an individual ad request very quickly, for instance in only a few milliseconds. At the same time, some DSPs typically receive as many as a million ad requests per second while hundreds of millions of users simultaneously explore the web around the globe. The short latency and high throughput requirements can introduce extreme time sensitivity into the process.

As yet another example, much information can be missing when individual ad requests are evaluated in real time or near real time. For instance, the feedback on previous decisions may have a long delay in practice. The collection of click information can be delayed because of the duplication removal during the logging process. At the same time, many view-through actions can take up to seven days to be converted and attributed to the corresponding impressions.

According to various embodiments, techniques and mechanisms described herein provide an online approach to enhancing performance metrics for an advertising campaign while satisfying budget constraints such as a smooth delivery constraint and/or a budget limit for the campaign. A control feedback loop may be applied to iteratively estimate the future spending rate in order to impose smooth delivery constraints. The spending rate may be used to select high quality impressions and adjust the bid price based on the prior performance distribution to maximize the performance goal.

In some implementations, budget pacing information may be used to determine whether and how to bid on individual advertising opportunity bid requests. When an incoming ad request is received, whether the ad request will eventually cause a click or conversion event may be unknown at the time of bid optimization. Accordingly, the value of an incoming ad request may be estimated by the prediction of its CTR or AR, for instance using a statistical model.

In some embodiments, campaign-specific performance metric threshold values may be used on a per-period basis to ensure that the smooth delivery constraint is met. At the same time, the use of such threshold values may facilitate the exploration of opportunities on the boundary of high and low quality advertising requests.

According to various embodiments, advertising campaigns may be designated as flat CPM or dynamic CPM. In a dynamic CPM campaign, the bid price is determined dynamically for each bid submitted. In a flat CPM campaign, each bid submitted has the same bid price. For a dynamic CPM campaign, one goal may be to adjust the bid price to meet a target pacing rate while providing improved expected value for successful bids.

According to various embodiments, a bid multiplier may be determined based on whether a per-period target pacing rate for an advertising campaign is above, within, or below a critical pacing rate range. According to various embodiments, when an ad request comes to the system, a performance metric such as click through rate (CTR) or action rate (AR) may be estimated. The performance metric may be used to determine a base bid price. The base bid price may be modified based on the bid multiplier to produce the actual bid price.

In some implementations, techniques and mechanisms may be described herein as solving “optimization” problems or as “optimizing” one or more parameters. It should be noted that the term optimize does not imply that the solution determined or parameter selected is necessarily the best according to any particular metric. For instance, some optimization problems are computationally intense, and computing the best solution may be impractical. Accordingly, optimization may involve the selection of a suitable parameter value or a suitably accurate solution. In some instances, the suitability of a parameter value or solution may be strategically determined based on various factors such as one or more computing capabilities, problem characteristics, and/or time constraints.

According to various embodiments, techniques and mechanisms may be described herein as distributing a daily budget for an advertising campaign over the course of a day. However, it should be noted that different advertising campaigns may have different types of budgets and/or budget constraints. For instance, the budgets for some advertising campaigns may be allocated and smoothed over the course of an hour, a week, a year, or some other time period to meet the needs of an advertiser.

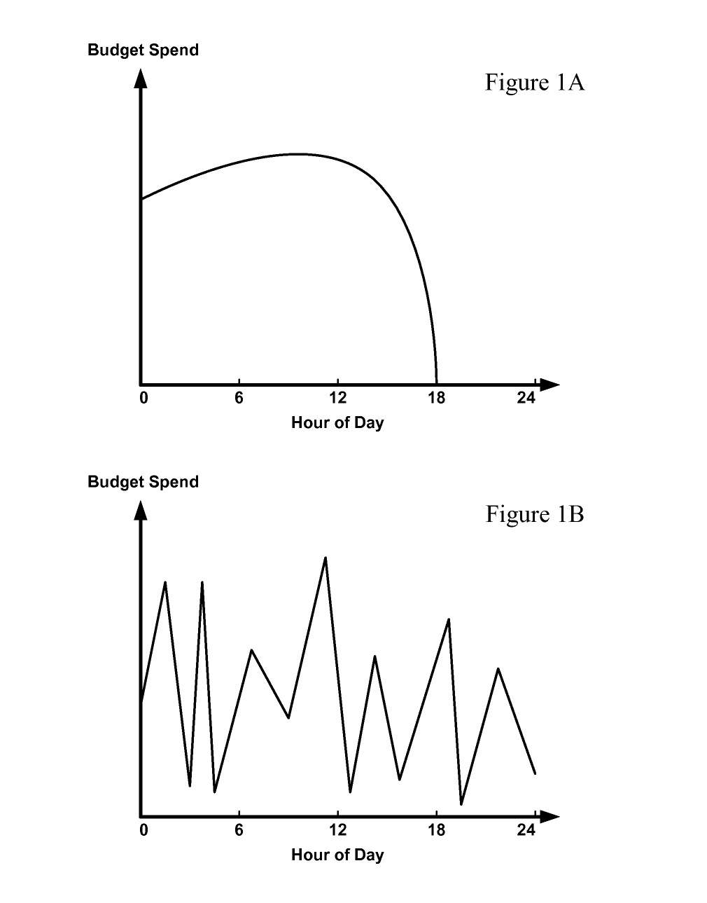

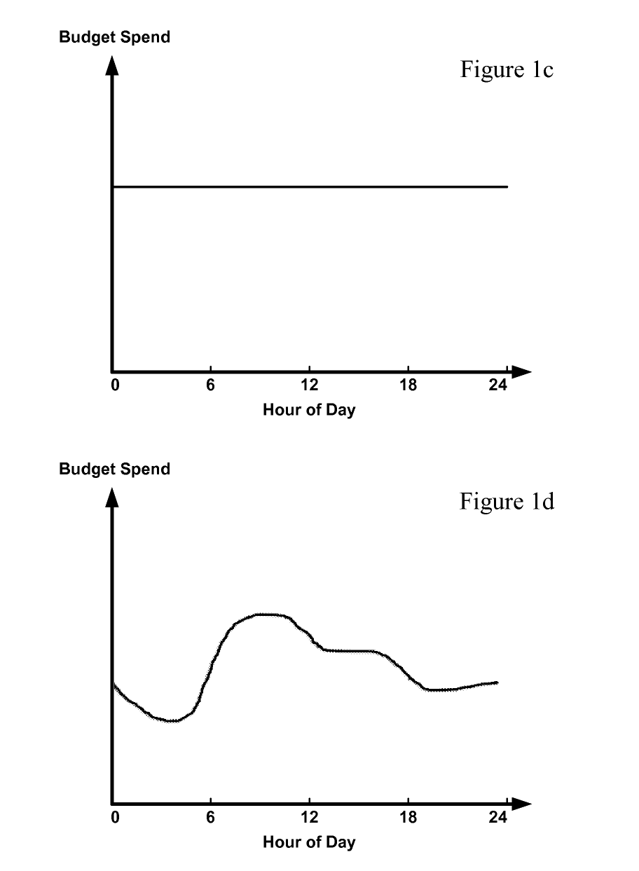

FIGS. 1A-E illustrates graphs of budget pacing schemes, presented in accordance with one or more embodiments. One example of a setting in which the budget pacing schemes illustrated in FIGS. 1A-E may occur is as follows. Suppose that a series of ad requests arrive sequentially. An advertiser would like to make a decision regarding whether to bid on each of the ad requests. The advertiser may specify a budget constraint such as a total daily budget to be spent on ad requests. In many advertising campaigns, advertisers would also like to impose a smooth budget delivery constraint to avoid situations such as a premature campaign stop or a fluctuating expenditure.

FIG. 1A illustrates an example of a premature campaign stop. In FIG. 1A, the entire daily budget of the advertising campaign is spent by hour 18. In this situation, the advertiser associated with the campaign has missed any opportunities that occur after hour 18 since no budget remains in the campaign for bidding on those advertising impressions. Accordingly, many advertisers would prefer to avoid a budget pacing scheme similar to that shown in FIG. 1A.

FIG. 1B illustrates an example of fluctuation in spend. Many advertisers prefer to avoid fluctuating spend for various reasons. For instance, many advertisers would like to be able to analyze their campaigns regularly, but high fluctuations in the budget may decrease the consistency of analysis results. Accordingly, many advertisers would prefer to avoid a budget pacing scheme similar to that shown in FIG. 1B.

FIG. 1C illustrates an example of an advertising campaign with uniform budget pacing. In this scheme the budget is uniformly split across the day. However, a uniform budget pacing scheme may impose one or more drawbacks. Accordingly, many advertisers would prefer to avoid a budget pacing scheme similar to that shown in FIG. 1C.

One potential drawback of a uniform budget pacing scheme is that, depending on the audience targeted by an advertising campaign, the volume of the online traffic can vary significantly throughout the day. For instance, it might be the case that traffic received during the first half of the day is more relevant than traffic received during the second half of the day. However, uniform budget pacing scheme ignores this difference in traffic relevance. In such a situation, some of the allotted budget may not be spent by the end of the day, or the budget may be spent on relatively low quality ad impressions in the second half of the day.

Another potential drawback of a uniform budget pacing scheme is that, the quality of the online traffic can change over the course of the day for different groups of an audience. Whether quality is being measured by CPC, CPA, CTR or AR, an advertiser may prefer that the budget be allocated primarily to time periods of the day with high quality. Due to these and other potential drawbacks associated with uniform budget pacing, a uniform budget pacing scheme may not meet the needs of at least some advertisers.

FIG. 1D illustrates an example of an advertising campaign with uniform budget pacing with respect to the traffic. In some instances, uniform budget pacing with respect to traffic may address some of the issues with uniform budget pacing with respect to time in terms of variation of traffic throughout the day. However, uniform budget pacing with respect to traffic may still ignore changes to the quality of the online traffic over the course of the day.

FIG. 1E illustrates an example of an advertising campaign with a budget pacing scheme that has a uniform baseline with additional budget portions allocated based on traffic quality. However, such a scheme may have large fluctuations that may violate smooth delivery constraints. As well, such a scheme may ignore changes in traffic volume over the course of the day.

In order to enforce the smooth delivery constraints, the overall daily budget B can be broken down into a sequence of time slot schedules {b₁, . . . , b_{T}}, where bₜ represents the budget that is allocated for advertising impressions available during time slot t. Since the entire budget is allocated for spending, the sum of the budgets allocated to the different time slots may be approximately or exactly equal to the overall budget for the day. According to various embodiments, various pacing strategies may be used to assign the bₜ values to select high quality impressions while adhering to one or more budget pacing conditions.

In some embodiments, each ad request i may fall within one of the time slot schedules. Each ad request xᵢ may be associated with a value vᵢ and a cost cᵢ. For instance, the value may be treated as representing the value for the advertiser if the given ad request is viewed by an audience member. The cost may be treated as representing the actual cost to the advertiser for the ad request, which is paid to the publisher who serves the corresponding impression.

In some implementations, the DSP may attempt to maximize the total value to the advertiser subject to the budget constraint. Accordingly, the DSP may attempt to solve the following maximization problem:

$$maximize {\sum }_{i = 1}^{n} {v}_{i} {x}_{i}$$

$$subject to {\sum }_{j ∈ {I}_{t}} {c}_{j} {x}_{j} \leq {b}_{t} ∀ t ∈ \{ 1 , … , T \}$$

In the preceding maximization problem, Iₜ represents the index set of all advertising requests that are received in the time slot t.

According to various embodiments, the maximization problem described in the immediately preceding paragraphs may be conceptualized as a theoretical or offline maximization problem since the cost and value of future ad requests may be unclear when decisions regarding budget pacing are made for a particular time period. That is, when an incoming ad request is received, a decision may need to be made regarding whether to bid on the ad request without observing data regarding future ad requests.

In particular embodiments, when bid values are determined dynamically, an estimated cost for the ad impression may need to be determined. In many RTB exchanges, the actual cost of an ad impression may be determined by an auction mechanism such as a second price auction. In such situations, a bid that is slightly higher than the estimated cost of the ad impression may need to be placed in order to win the second price auction and pay the estimated cost. The actual value of the bid placed for a given ad impression may be strategically determined based on one or more of various factors such as the characteristics of the auction employed by the RTB and the estimated cost of the ad impression.

Various approaches to solving optimization problems of the types described herein may suffer from one or more drawbacks. For example, some approaches to solving optimization problems model the budget constrained bidding optimization problem as an online knapsack problem (e.g., which is analogous to determining what packages are within a closed knapsack based on known weights of individual packages and filled knapsack). When employing such approaches, high quality ad requests may be selected based on an exponential function with respect to the budget period. As time goes by, increasingly higher quality ad requests can be selected. However, these types of approaches may rely on an underlying assumption of unlimited supply of future ad requests in the RTB environment. Such an assumption is impractical in many advertising campaigns, such as those campaigns with strict audience targeting constraints.

As another example, the problem of dynamic bidding price may be formulated using a multi-armed bandit framework (e.g., which is analogous to a gambler facing a set of slot machines or “one-armed bandits” and determining which slot machines to play, how many times to play each slot machine, and in which order to play the slot machines). Then, the strategy of upper confidence bound may be applied to explore the optimal price of online transactions. However, multi-armed bandit frameworks typically need to collect feedback quickly from the environment in order to update the utility function. The collection of bidding and performance information often involves a longer delay for display advertising in an RTB environment, thus rendering this approach impractical in many situations.

As yet another example, a general online linear programming algorithm may be used. A standard linear programming solver may be used to compute the optimal dual solution for the data which have been seen in the system. Then, the solution for the new instance can be decided by checking if the dual solution with the new instance satisfies the constraint. However, the true value and cost parameters for an incoming ad request may be unknown when the ad request arrives at the system. If these parameters are estimated, then the dual solution may need to be re-computed more frequently for each campaign in order to impose budget constraints accurately. This frequent re-computation may introduce high computational cost in the real time bidding system.

According to various embodiments, advertising campaigns may be divided into at least two categories. One category includes flat CPM campaigns, in which the same bid price is submitted whenever a decision is made to bid on an advertising request. Another category includes dynamic CPM campaigns, in which the bid price is dynamically determined. In both types of campaigns, a determination is made as to whether to bid on an advertising request.

In some embodiments, different metrics may be used to evaluate decisions made in different types of campaigns. For instance, the success of decisions made in a flat CPM campaign may often be based on a metric such as CTR or AR. In contrast, the success of decisions made in a dynamic CPM campaign may be based on a metric such as effective CPC (eCPC) or effective CPA (eCPA). The eCPC may be the cost-per-click that is actually realized, while the CPC may be the desired cost-per-click. Similarly, the eCPA may be the cost-per-action that is actually realized, while the CPA may be the desired cost-per-action.

According to various embodiments, the following optimization problem illustrates the type of calculation that may be performed in order to determine whether to bid on an ad request and, if in a dynamic CPM campaign, what bid to place on the ad request.

$$minimize - CTR , - AR , eCPC , or eCPA$$

$$such that \vert {\sum }_{t}^{T} s ( t ) - B \vert \leq ε$$

$$\vert s ( t ) - {b}_{t} \vert \leq {δ}_{t} ∀ t ∈ \{ 1 , … , T \}$$

$$eCPM \leq M$$

According to various embodiments, the first constraint in the preceding optimization problem may be treated as the total daily budget constraint, where s(t) represents the budget spent during time slot t, and ε represents an upper bound on the underspend or overspend total. The second constraint may be treated as enforcing smooth budget delivery according to the schedule bₜ, where δₜ represents an upper bound on the underspend or overspend for time slot t. The third constraint may be treated as requiring that eCPM does not exceed the cap M. This constraint may help make a dynamic CPM campaign to appear more like a CPM campaign on average over time.

According to various embodiments, the preceding optimization problem may be used to select the parameter bₜ. For instance, the total budget B and the average impression cost cap M may be set for a campaign by the advertiser.

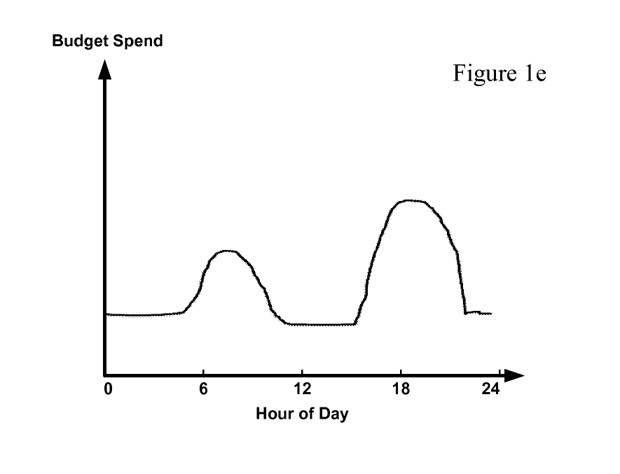

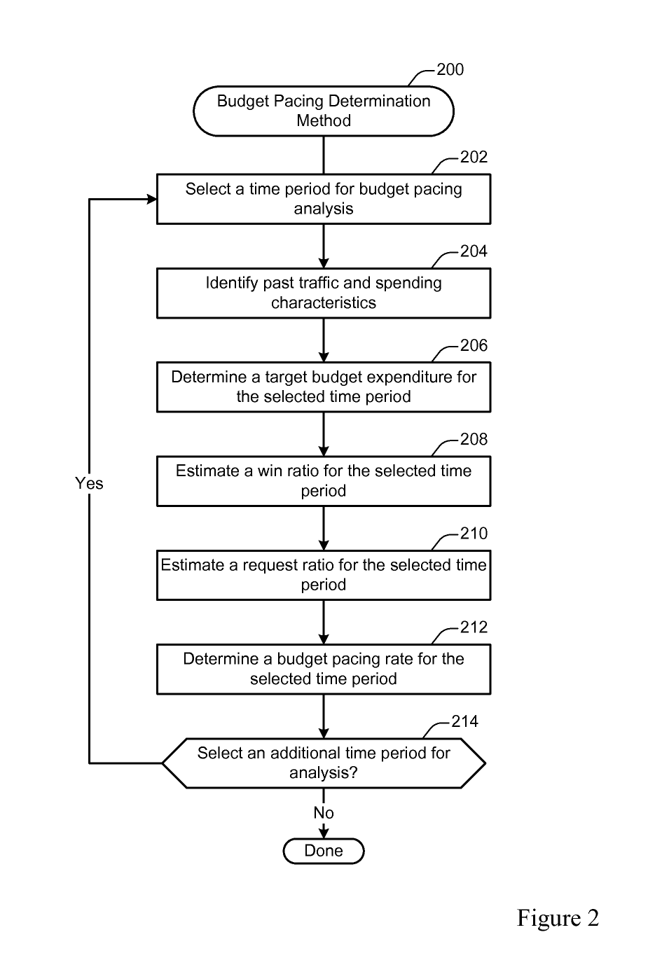

FIG. 2 illustrates an example of a budget pacing determination method 200, performed in accordance with one or more embodiments. The method 200 may be used to calculate a delivery schedule in real-time or near real-time for an advertising campaign. For example, the delivery schedule may be used to spread out the actions of acquiring impressions for a campaign throughout the day. For instance, a day can be broken down into T time periods. In each time period, a target budget can be assigned for spending in association with the each campaign.

Since advertising requests may be purchased via an auction mechanism, the actual budget spent for a time period may differ somewhat from the target budget for the time period. For instance, the actual amount spent during a time period may be determined by factors such as the bid amount for the time period, the win rate for the time period, and the number of requests bid upon during the time period.

In some embodiments, the delivery schedule may designate a per-period pacing rate for a time period in order to spend approximately the target budget for the time period. The pacing rate may designate the portion of incoming ad requests that are bid on for the campaign during the time period. For instance, the pacing rate may indicate that 15% of the incoming ad requests during the time period are to be bid on for the advertising campaign.

At 202, a time period for budget pacing analysis is selected. According to various embodiments, decisions regarding budget pacing may be made in real-time or near real-time. Accordingly, the time period selected for analysis may be the next time period in which advertising requests are received. Initially, the first time period may be selected.

According to various embodiments, a day may be divided into various numbers of time periods. For instance, a day may be divided into time periods of ten seconds, one minute, five minutes, or any suitable length of time. In some campaigns, all time periods for a campaign may be assigned to have equal length. Alternately, in some campaigns, different time periods may have different lengths.

In some embodiments, the amount of money spent during a given time period is considered to be proportional to the number of impressions served at that time period. This amount of money spent during a time period may be referred to as the “spend” of acquiring inventory for the time period. In general, the price of individual impressions for a particular campaign may remain approximately constant during a given time period. For instance, the length of the time period may be chosen such that the variance of individual impression price for each campaign is small.

At 204, past traffic and spending characteristics are identified. According to various embodiments, various types of information associated with previous time periods may be used to facilitate the determination of a pacing rate for the time period being analyzed. The past traffic and spending characteristics may include, but are not limited to, the actual spend for one or more previous periods, the pacing rate for one or more previous periods, the win rate for one or more previous periods, the number of requests for one or more previous periods, and various historical data.

In some embodiments, past traffic and spending characteristics may be stored in a storage system for the purpose of traffic analysis. For instance, when a time period is completed, information regarding the advertising requests received, the bids placed, the budget spent, and other such characteristics may be stored. Some or all of this information may then be retrieved for analysis during subsequent time periods.

In some embodiments, the actual spend for a previous time period may indicate that actual amount of budget that was spent on advertising requests for the previous time period. The actual amount spent may depend on factors such as the bid amount for the previous time period, the number of bids bid upon during the previous time period, and the percentage of successful bids during the previous time period.

In some embodiments, the win rate for a previous time period may identify the percentage or proportion of bids placed during the previous time period that were successful. For instance, if bids were placed on 5,000 adverting requests during the previous time period and the advertising campaign was successful in purchasing 1,000 of those requests, then the win rate for the previous time period would be 20%.

In some embodiments, the number of requests for a previous time period may identify the number of advertising requests for the previous time period on which it would have been possible to place a bid. In some instances, the number of requests may be defined as the number of available advertising requests that fall within one or more constraints or conditions specified by the advertising campaign. For instance, the advertising campaign may target one or more specific audiences or exclude one or more specific audiences.

In some embodiments, historical data from one or more previous time periods may be identified. Historical data may be used to make predictions regarding the time period selected for analysis. For example, historical data may indicate information such as a number of requests received during a previous time periods in the same day and/or a number of requests received during a previous time period in a previous day. As another example, historical data may indicate information such as a win rate during a previous time periods in the same day and/or a win rate during a previous time period in a previous day.

At 206, a target budget expenditure is determined for the selected time period. According to various embodiments, various techniques may be used to determine the target budget spend. For example, in a uniform budget pacing approach, the budget may be spent approximately evenly over the course of a day. As another example, relatively higher budget amounts may be allocated to time slots where a campaign has a greater chance to spend the budget on higher quality ad impressions. A higher quality ad impression may be one that has an increased probability of triggering an event of interest such as a click or conversion.

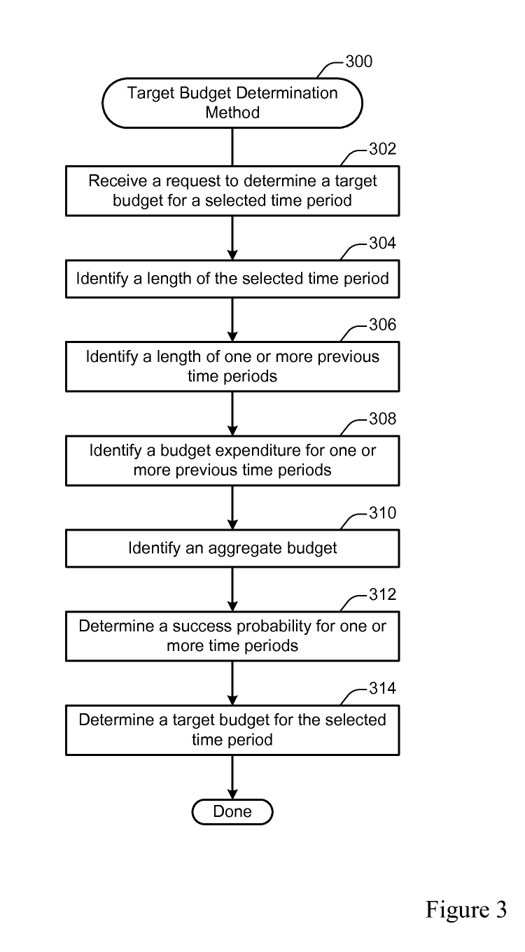

According to various embodiments, any of various types of budget distributions may be applied to an advertising campaign by selecting an appropriate target budget for each time period. For example, an approximately uniform pacing strategy may be implemented by adjusting the ideal budget expenditure to be approximately even over the course of the day. As another example, the target budget may be selected to weight certain periods of the day more highly. FIG. 3 describes examples of methods that may be used to determine a target budget for a time period according to different budget pacing strategies.

At 208, a win ratio for the selected time period is estimated. According to various embodiments, the estimated win ratio for the selected time period may identify an estimated ratio of win rates for different time periods. For instance, the estimated win ratio for the selected time period may identify an estimated ratio of the win rate for the immediately preceding time period and the estimated win rate for the selected time period.

In some embodiments, the win ratio for the selected time period may be estimated by combining information describing actual win ratios. For instance, the actual win ratio for the selected time period and the immediately preceding time period may be combined with historical information such as actual win ratios for time periods during previous, hours, days, or weeks.

At 210, a request ratio for the selected time period is estimated. According to various embodiments, the estimated request ratio for the selected time period may identify an estimated ratio of numbers of requests received during different time periods. For instance, the estimated request ratio for the selected time period may identify an estimated ratio of the number of requests received during the immediately preceding time period and the estimated number of requests to be received during the selected time period.

In some embodiments, the request ratio for the selected time period may be estimated by combining information describing actual numbers of requests. For instance, the actual number of requests for the selected time period and the immediately preceding time period may be combined with historical information such as actual numbers of requests for time periods during previous, hours, days, or weeks.

At 212, a budget pacing rate is determined for the selected time period. According to various embodiments, the budget pacing rate may identify the proportion of incoming ad requests received during the selected time period on which to bid. The budget pacing rate may be determined based on any of various factors which may include, but are not limited to: the estimated win ratio for the selected time period, the estimated request ratio for the selected time period, the target budget expenditure for the selected time period, and the budget expenditure for the immediately preceding time period.

In some embodiments, the budget pacing rate may be determined by calculating the result of a formula such as the following formula:

$$pacing\_rate ( t ) = \frac{target\_budget ( t )}{budget\_spent ( t - 1 )} * request\_ratio ( t ) * win\_ratio ( t )$$

In some embodiments, the formula may be written as follows:

$$pacing\_rate ( t ) = \frac{target\_budget ( t )}{budget\_spent ( t - 1 )} * \frac{requests ( t - 1 )}{requests ( t )} * \frac{win\_rate ( t - 1 )}{win\_rate ( t )}$$

In some embodiments, determining the budget pacing rate may involve storing the budget pacing rate on a storage system or in memory. The budget pacing rate may then be used to identify incoming ad requests on which to bid. For instance, if the budget pacing rate is 10%, then 10% of the incoming ad requests received during the selected time period that meet the criteria of the advertising campaign may be bid upon.

In particular embodiments, a pacing rate may be saved to local storage, for instance in a control server, when the pacing rate is updated. If the service is restarted, the pacing module may attempt to re-load all previous pacing information to avoid resetting the pacing rate to the initial values.

In particular embodiments, a pacing rate may be decreased below the rate that would otherwise be used as the day or other longer time interval draws to a close in order to prevent overspending. In some instances, a module may periodically determine whether the current aggregate spend is less than the daily cap and the cap for the selected time interval.

In particular embodiments, different pacing strategies may be executed for different types of advertising requests. Alternately, or additionally, pacing strategies may be changed by altering the techniques used to compute the pacing rate. For instance, one formula used to compute a pacing rate may be substituted for a different pacing rate formula.

At 214, a determination is made as to whether to select an additional time period for analysis. As discussed with respect to operation 202, decisions regarding budget pacing may be made in real-time or near real-time. Accordingly, the time period selected for analysis may be the next time period in which advertising requests are received. When a time period has passed, the next time period may be selected. For instance, time periods may continue to be selected until the advertising campaign or the day is completed.

FIG. 3 illustrates an example of a target budget determination method 300, performed in accordance with one or more embodiments. According to various embodiments, the method 300 may be performed in succession for a number of time periods in order to distribute a budget approximately uniformly over the time periods. For instance, the method 300 may be performed for each time period within a day in order to distribute the budget for the day uniformly over the day.

At 302, a request to determine a target budget for a selected time period is received. According to various embodiments, the request may be received as part of a procedure for determining a pacing rate for the selected time period, as discussed with respect to FIG. 2. For instance, the request may be generated in conjunction with the operation 206 described with respect to FIG. 2.

At 304, a length of the selected time period is identified. According to various embodiments, the length of the selected time period may indicate the amount of time during which operations associated with the selected time period take place. For instance, the target budget may be determined for use during the selected time period. The target budget for the time period may then be applied to ad requests received during the selected time period.

According to various embodiments, the length of time and other parameters may be determined by retrieving them from memory or a storage system. For instance, the system may store information such as the length of time of each time period, the budget expenditure for past time periods, and other parameters. This information may then be retrieved upon request for use in analysis or for other purposes.

At 306, a length of one or more previous time periods is identified. For instance, the length of each time period during the course of the day may be identified. The lengths of previous time periods may be identified individually or in the aggregate. For example, a running total of the length of time associated with all previous time periods during the course of the day may be maintained and updated.

In some implementations, each time period may be assigned the same length. Alternately, different time periods may be assigned different lengths. For instance, some periods of the day may be associated with high volatility in terms of the quantity and quality of advertising requests received and thus may be assigned shorter time periods. Other periods of the day may be associated with low volatility and be assigned longer time periods.

At 308, a budget expenditure for one or more previous time periods is identified. For instance, the budget expenditure of each time period during the course of the day may be identified. The budget expenditures of previous time periods may be identified individually or in the aggregate. For example, a running total of the budget expenditure associated with all previous time periods during the course of the day may be maintained and updated.

At 310, an aggregate budget is identified. According to various embodiments, the aggregate budget may identify a budget amount that is allocated for expenditure over a longer interval of time. The aggregate budget may be identified in order to divide the aggregate budget into allocations for the longer time interval among the different time periods in such a way that the budget constraint for the longer time interval is satisfied. For instance, the aggregate time interval may indicate an amount of money allocated for expenditure over a day, a week, an hour, or some other interval of time.

In some implementations, the aggregate budget may identify a target budget expenditure for the longer time interval. Alternately, or additionally, the aggregate budget may identify a maximum budget for the longer time interval.

At 312, a success probability for one or more time periods is determined. In some implementations, the success probability may be used to incorporate historical information into budget pacing analysis. For instance, an advertising campaign and/or pacing procedure designer may incorporate domain-specific knowledge into budget pacing.

For example, a designer with knowledge or experience in car dealing might believe that advertising during particular hours of the day or days of the week is more successful than advertising during other time periods. Based on this knowledge, the designer may define success probabilities to bias the budget pacing toward these desirable time periods.

As another example, a business owner may choose to restrict advertisement to a time period encompassing the hours of operation of the business. For instance, most advertising may be performed when the business is open, with a gradual increase in advertisement during the time period before the business opens. Suppose, for instance, that the business is a restaurant. The restaurant may prefer to begin presenting advertisements in the hours leading up to lunch time. Then, advertisement may be decreased during the early afternoon and increased again closer to the dinner time.

In some implementations, a success probability for a time period may indicate the probability of a click, conversion, or other successful outcome for the time period. Alternately, a success probability may be associated or correlated with the probability of a successful outcome. A success probability may be calculated exactly or estimated. For instance, a success probability may be determined by analyzing campaign history data or measuring the performance of the campaign during previous time periods.

According to various embodiments, potentially many different success probabilities may be determined. For instance, success probabilities may be combined to produce a discrete probability density function that assigns a success probability for each period during the course of a longer time interval such as a day. When a discrete probability density function is used, the success probabilities over the course of the day may sum to one. In such a model, higher probabilities may be associated with higher success rates but may not indicate the actual estimated success rate for a given time period. In this way, a probability density function may be used to weight the budget allocation among the different time periods based on the relative quality of the ad impressions received in different time periods.

In some implementations, one or more actual success metrics may be calculated exactly, as opposed to success probabilities, based on received success metric information for a given time period. Alternately, or additionally, one or more success probabilities may be estimated for the selected time period and even for periods in the past since information regarding the success of recent advertisements may be unavailable for a period of time.

At 314, a target budget for the selected time period is determined. According to various embodiments, the target budget for the selected time period may be determined by any of various budget pacing strategies. For example, a uniform budget pacing strategy may be applied. As another example, a budget pacing strategy may allocate a larger budget to time periods in which advertising requests have a higher probability of success. For instance, some periods of time may be associated with a higher probability of clicks or conversions for advertising requests.

In some implementations, the target budget may be determined based on a uniform pacing strategy. A uniform pacing strategy may attempt to spend the aggregate budget evenly over the course of the day, even as the number and quality of advertising requests changes. For instance, the target budget bₜ for period t may be calculated based on the following formula. In this formula, B represents the aggregate budget, spend(m) represents the budget expenditure during the time period m, L(t) represents the length of the selected time period t, and L(m) represents the length of the previous time period m.

$${b}_{t} = ( B - {\sum }_{m = 1}^{t - 1} spend ( m ) ) \frac{L ( t )}{{\sum }_{m = t}^{T} L ( m )}$$

In some implementations, each time period during a longer interval such as a day may be assigned an equal length. When such a strategy is implemented, the previous equation may be simplified to the following formula. In the following formula, T represents the total amount of time that is divided into time intervals. For instance, T may represent the amount of time that passes during one day.

$${b}_{t} = ( B - {\sum }_{m = 1}^{t - 1} spend ( m ) ) \frac{1}{T - t}$$

In some implementations, a budget pacing strategy may allocate a larger portion of the budget to time periods in which advertising requests have a higher probability of success. For instance, the target budget bₜ for period t may be calculated based on the following formula. In this formula, Pₜ represents the probability of success during period t. As described herein, the probability of success may be defined in various ways based on the strategic objectives of the advertising campaign.

$${b}_{t} = ( B - {\sum }_{m = 1}^{t - 1} spend ( m ) ) \frac{{p}_{t} \cdot L ( t )}{{\sum }_{m = t}^{T} {p}_{m} L ( m )}$$

In some implementations, each time period during a longer interval such as a day may be assigned an equal length. When such a strategy is implemented, the previous equation may be simplified to the following formula. In the following formula, T represents the total amount of time that is divided into time intervals. For instance, T may represent the amount of time that passes during one day.

$${b}_{t} = ( B - {\sum }_{m = 1}^{t - 1} spend ( m ) ) \frac{{p}_{t}}{{\sum }_{m = t}^{T} {p}_{m}}$$

In some implementations, initialization values may be used when calculating formulas described herein, for instance for the first period of the day. For example, initialization values may be set based on the results of time intervals in previous days. As another example, initialization values may be set to designated constant values such as zero values, small non-zero values, or other constant values.

In some implementations, one or more of the operations shown in FIG. 3 may be omitted. Alternately, or additionally, one or more additional operations not shown in FIG. 3 may be performed. For example, when implementing a uniform budget pacing strategy, determining a success probability may be omitted. As another example, other budget pacing strategies may involve information not discussed with respect to FIG. 3. In particular embodiments, the specific information used to determine the target budget may be strategically determined based on the type of budget pacing being performed.

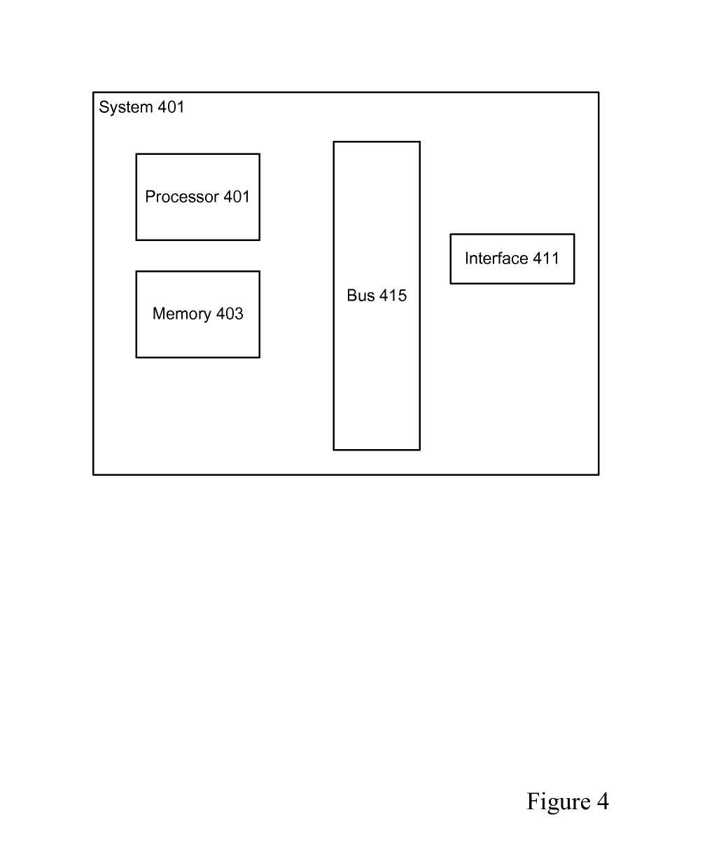

FIG. 4 illustrates one example of a server. According to particular embodiments, a system 400 suitable for implementing particular embodiments of the present invention includes a processor 401, a memory 403, an interface 411, and a bus 415 (e.g., a PCI bus or other interconnection fabric) and operates as a counter node, aggregator node, calling service, zookeeper, or any other device or service described herein. Various specially configured devices can also be used in place of a processor 401 or in addition to processor 401. The interface 411 is typically configured to send and receive data packets over a network.

Particular examples of interfaces supported include Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. Although a particular server is described, it should be recognized that a variety of alternative configurations are possible.

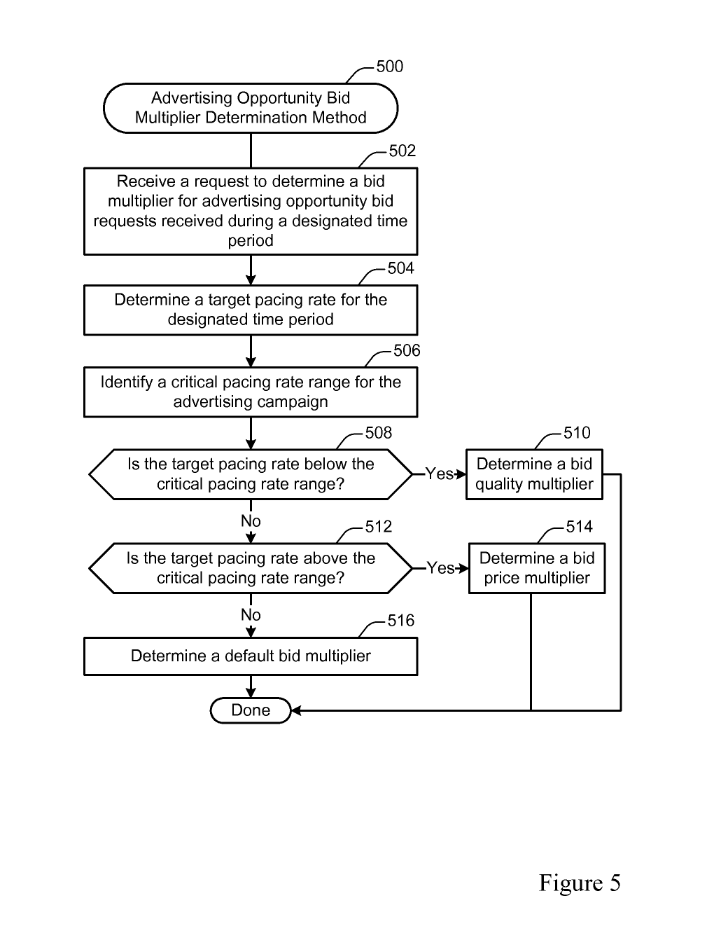

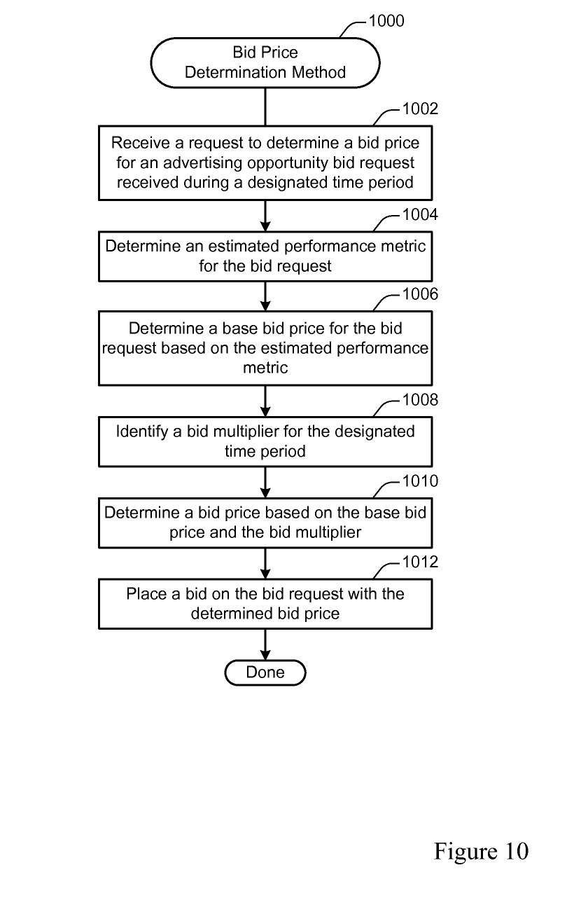

FIG. 5 illustrates an example of a method 500 for determining an advertising opportunity bid multiplier. According to various embodiments, the method 500 may be performed in order to select a bid multiplier so as to meet a target pacing rate and/or improve advertising opportunity expected value for an advertising campaign. The bid multiplier may be used to adjust a base bid price in order to meet the performance goals of the advertising campaign. The adjustment of a base bid price using a bid multiplier is discussed in further detail with respect to FIG. 10.

At 502, a request is received to determine a bid multiplier for advertising opportunity bid requests received during a designated time period. According to various embodiments, the request may be generated as part of a partially or fully automated system configured to manage advertising bid placement and advertising budget expenditure for one or more advertising campaigns. In some implementations, a single bid multiplier may be determined for more than one time period, for instance to reduce the system's computational load.

According to various embodiments, the designated time period may be of any of various lengths of time. For instance, the designated time period may be on the order of seconds, minutes, or hours. In some instances, different time periods may have different lengths. Alternately, different time periods may each be of the same length of time.

At 504, a target pacing rate for the advertising campaign is identified. According to various embodiments, the target pacing rate may identify the proportion of incoming ad requests received during the designated time period on which to bid. The target pacing rate for the designated time may be determined as discussed with respect to operation 212 shown in FIG. 2. For instance, the target pacing rate may be determined so as to meet campaign-specific performance goals.

At 506, a critical pacing rate range for the advertising campaign is identified. According to various embodiments, the critical pacing rate range may indicate a proportion region in which submitting base bid values for advertising opportunity bid requests may be expected to result in a pacing rate that is approximately equal to a target pacing rate. The critical pacing rate range may include a lower threshold value, such as 0.7, and an upper threshold value, such as 0.9.

In some implementations, the upper and lower threshold values may be strategically determined based on various considerations such as historical bid success rates, advertising campaign performance metrics, and the number of time periods remaining in a longer time interval such as a day. For instance, the lower value may be selected as any value between zero and one (inclusive), and the upper value may be selected as any value between the lower value and one (inclusive). For example, the lower threshold value may be selected from a range of threshold values between 0.05 and 0.5. As another example, the upper threshold value may be selected from a range of threshold values between 0.5 and 0.95.

At 508, a determination is made as to whether the current pacing rate is below the critical pacing rate range. According to various embodiments, when the per-period target pacing rate for the advertising campaign is below a critical range, the advertising campaign may be in an effectively safe range. In the safe range, the advertising campaign may suffer little or no threat of under delivery of successful advertising bids, since relatively many advertising opportunity bid requests may be expected during the time period as compared to the target pacing rate. For instance, if the per-period target pacing rate is 0.25, then only one in every four bid requests received during the designated time period need to be purchased to meet the pacing rate.

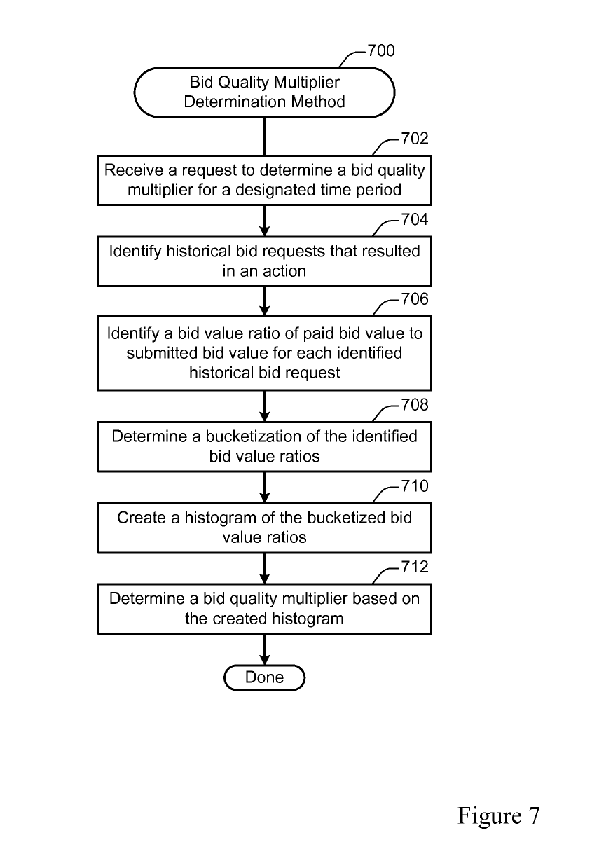

At 510, a bid quality multiplier is determined if the current pacing rate is below the critical pacing rate range. According to various embodiments, the bid quality multiplier may be a value selected to increase the expected value of advertising opportunities that are successfully bid upon. For instance, the expected value of an advertising opportunity may be identified as a difference between the price paid for the advertising opportunity and the revenue expected to be generated by the advertising opportunity. Since the base bid price may be determined based on the expected value of a successful bid, decreasing the bid price to below the base bid price may mean that the expected value of the bid would be increased if the bid is successful. At the same time, a relatively lower number of bids may succeed due to the bid price being lowered. However, since the target pacing rate is relatively low, the advertising campaign can afford to experience a reduced bid success rate for the designated time period. Examples of techniques for determining a bid quality multiplier are described with respect to the method 700 shown in FIG. 7.

At 512, a determination is made as to whether the current pacing rate is above the critical rate range. According to various embodiments, when the target pacing rate is above a critical range, the advertising campaign may suffer a significant threat of under delivery of successful advertising bids, since relatively few advertising opportunity bid requests may be expected during the time period as compared to the target pacing rate. For instance, if the per-period target pacing rate is 0.95, then 19 in every 20 bid requests received during the designated time period need to be purchased to meet the pacing rate. Accordingly, when the target pacing rate is above the critical range, then the advertising campaign may be in a dangerous pacing rate range in which the campaign is at risk of not meeting one or more target performance metric goals such as a target budget expenditure.

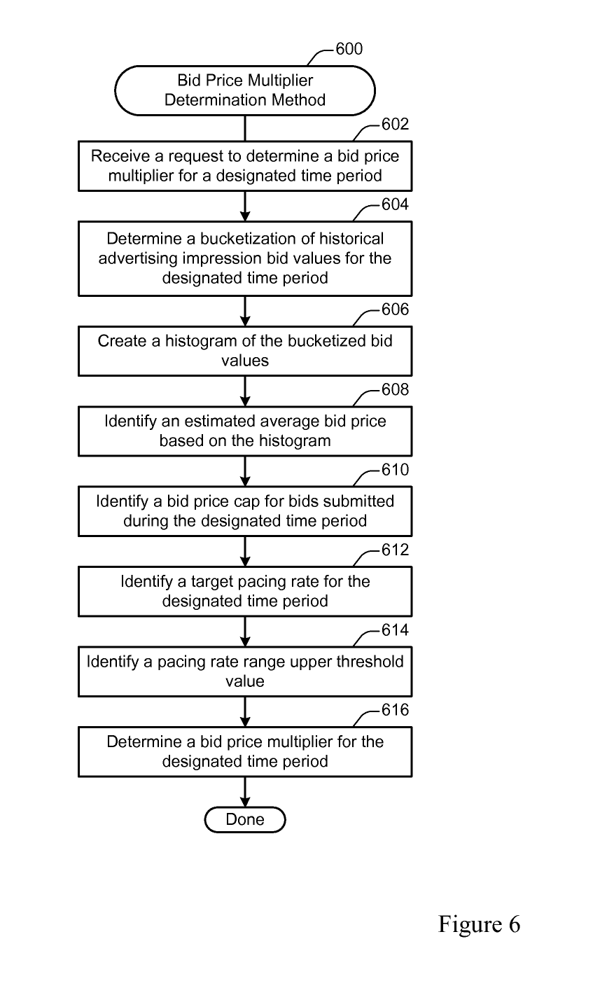

At 514, a bid price multiplier is determined if the current pacing rate is above the critical rate range. According to various embodiments, the bid price multiplier may be a value selected to increase the bid price beyond a base bid price so that a potentially greater proportion of submitted bids are successful. For instance, the bid price multiplier may be a value greater than one. Examples of techniques for determining a bid price multiplier are described with respect to the method 600 shown in FIG. 6.

In particular embodiments, a bid price multiplier may decrease the expected value from successful bid requests since it may have the effect of increasing the amount paid. However, the bid price multiplier may also increase the proportion of successful bid requests and thus may help to ensure that the advertising campaign remains on track to meet one or more target performance metric goals such as a target budget expenditure.

At 516, a default bid multiplier may be determined. According to various embodiments, a default bid multiplier may be a bid multiplier that is applied when the target pacing rate for an advertising campaign is within the critical pacing rate range. For instance, the default bid multiplier may be one or a value close to one. When the pacing rate for an advertising campaign is within the critical pacing rate range, little or no adjustment to the base bid price computed for an incoming advertising opportunity bid request may be needed. In this situation, the proportion of successful bids is expected to approximately meet the target pacing rate when a base bid price is used.

FIG. 6 illustrates a method 600 for determining a bid price multiplier, performed in accordance with one or more embodiments. According to various embodiments, a bid price multiplier may be used to increase the bid price beyond a base level in order to achieve a greater success rate for bids placed for an advertising campaign. For instance, a bid price multiplier may be used if a target pacing rate for an advertising campaign is relatively close to one, indicating that almost all of the bids placed for the advertising campaign during the time period need to be successful if the advertising campaign is to meet its target pacing rate.

In some implementations, the target pacing rate for an advertising campaign may rise above a critical pacing rate range for various reasons. For example, audience targeting constraints for the advertising campaign may be overly restrictive, resulting in an insufficient supply of incoming ad requests selected for bidding. As another example, the bid price submitted in response to selected advertising opportunity bid requests may be too low to win a sufficient amount of auctions, even if bids are submitted quite frequently. In some instances, a bid price multiplier may be applied to increase the number of successful bids and thus increase the actual pacing rate of the advertising campaign in order to reach a relatively high target pacing rate.

At 602, a request to determine a bid price multiplier for the designated time period is received. According to various embodiments, the request may be generated as part of a partially or fully automated system configured to manage advertising bid placement and advertising budget expenditure for one or more advertising campaigns. For instance, a request to determine a bid price multiplier may be generated at operation 514 shown in FIG. 5. In some implementations, a single bid price multiplier may be calculated for more than one time period, for instance to reduce the system's computational load.

At 604, a bucketization of historical advertising impression bid values is determined for the designated time period. According to various embodiments, determining the bucketization may involve identifying bid value ranges and counting the number of ad requests that fall within each range. Various techniques exist for bucketization. For instance, buckets may be of fixed size or variable size, with size measured either by the number of ad requests within the bucket or the length of the range of the bucket.

In some implementations, the historical advertising impression bid values may be metrics collected for past advertising activity for the advertising campaign. Alternately, or additionally, historical advertising impression bid values for other advertising campaigns may be used. For instance, an advertising campaign may be associated with a relatively limited amount of historical information for use in estimating incoming ad request patterns.

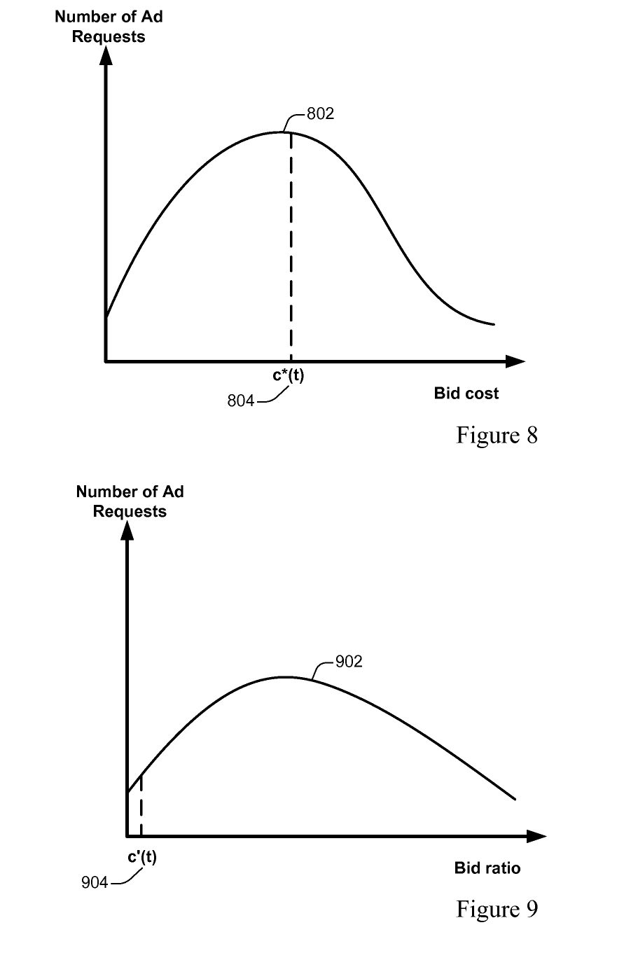

At 606, a histogram of the bucketized performance metrics is created. According to various embodiments, the histogram may be created by estimating a distribution based on the bucketization of the historical advertising impression bid prices determined as discussed with respect to operation 706. An example of a histogram of the bucketized bid prices is shown at 802 in FIG. 8.

At 608, an estimated average bid price is identified based on the histogram. According to various embodiments, the estimated average bid price may indicate the estimated average of the bid price needed to win bids received during the designated time period. For instance, the estimated average may be computed by determine the median value of the histogram created as discussed in operation 608. When the median observation is computed, approximately half of the observations in the histogram will be below the median observation and approximately half of the observations will be above the median observation. An example of an estimated average c*(t) at 804 in FIG. 8.

At 610, a bid price cap for bids submitted during the designated time period is identified. According to various embodiments, the bid price cap may be set by any of various entities. These entities may include, but are not limited to, the RTB from which a bid originates, the advertiser the advertising campaign management system.

According to various implementations, a bid price cap may indicate any of various types of information. For example, the bid price cap may indicate the upper end of reasonable bid amounts. For instance, an RTB may set a bid price cap to avoid mechanically-driven bidding wars between different algorithms that drive bid prices unreasonably high. As another example, the bid price cap may be set by an advertiser to indicate the upper end of what the advertiser is willing to pay for advertising requests in an advertising campaign. As yet another example, the bid price cap may be set by a system administrator of an advertising campaign management system to indicate the upper end of what the administrator believes that advertisers would be willing to pay for an individual advertising request.

At 612, a target pacing rate for the designated time period is identified. According to various embodiments, the budget pacing rate may identify the proportion of incoming ad requests received during the designated time period on which to bid. The budget pacing rate for the designated time may be determined as discussed with respect to operation 212 shown in FIG. 2.

At 614, a pacing rate range upper threshold value is identified. According to various embodiments, the pacing rate range upper threshold value may designate the upper end of a target pacing rate range. The target pacing rate range may be identified, for instance, as discussed with respect to operation 508 shown in FIG. 5.

At 616, a bid price multiplier is determined for the designated time period. According to various embodiments, various techniques may be used to determine the bid price multiplier. For instance, the bid price multiplier may be determined based on values such as the bid price cap, the target pacing rate for the designated time period, the pacing rate range upper threshold value, and/or the estimated average bid price.

In some implementations, the bid price multiplier ρ may be calculated based on the following equation. In the following equation, C represents the bid price cap, c* represents the estimated average bid price, and β₂ represents the pacing rate range upper threshold value.

$${ρ}^{*} = 1 + \frac{C / {c}^{*} - 1}{1 - {β}_{2}} ( pacing\_rate ( t ) - {β}_{2} )$$

FIG. 7 illustrates a method 700 for determining a bid quality multiplier, performed in accordance with one or more embodiments. According to various embodiments, a bid quality multiplier may be used to improve the quality of successful bids when an advertising campaign has a target pacing rate that is below a critical pacing rate range. Then, the bid quality multiplier may be applied to adjust the base bid price of bids submitted in response to advertising opportunity bid requests received during the designated time period.

According to various embodiments, when the target pacing rate for an advertising campaign is below the critical range, the campaign may be able to afford to submit relatively lower bids. Submitting lower bids may result in relatively fewer bids being successful. However, the bids that are successful may have a relatively higher expected value since the amount paid for the bids may be reduced.

In some implementations, when an advertising campaign is operating with a target pacing rate below a critical range, the advertising campaign management system can determine an improved bid price from the auction results. For instance, the system may identify a difference between submitted bid price and the paid bid price in an auction mechanism such as a second price auction. This difference may be identified for past advertising opportunities that resulted in an auction and/or past advertising opportunities that did not result in an action.

In particular embodiments, relatively high quality impressions may have larger differences between submitted bid values and paid bid values than relatively lower quality impressions. For instance, the CTR or AR estimator for incoming bid requests may be expected to generate a relatively higher estimated CTR or AR for higher quality impressions. A relatively higher estimated CTR or AR may result in higher bid values and hence a larger difference from the paid values unless all bidders use the same or similar CTR or AR estimation algorithm.

At 702, a request to determine a bid quality multiplier is received. According to various embodiments, the request may be generated as part of a partially or fully automated system configured to manage advertising bid placement and advertising budget expenditure for one or more advertising campaigns. For instance, a request to determine a bid quality multiplier may be generated at operation 510 shown in FIG. 5. In some implementations, a single bid quality multiplier may be calculated for more than one time period, for instance to reduce the system's computational load.

At 704, historical bid requests that resulted in an action are identified. According to various embodiments, an action may be any measurable result of an advertising request. For instance, an action may be a click, a purchase, a conversion, or any other type of result that may occur when an advertisement is presented to a recipient.

In some implementations, the historical bid requests may be identified by analyzing historical information describing past bid and advertising request activity. The historical information may identify various types of data for one or more advertising opportunity bid requests received in a previous time period. For example, the historical information may identify whether a bid was submitted for an advertising request, the value of a bid that was submitted, whether a submitted bid was successful, and/or the amount paid for a successful bid. As another example, the historical information may identify whether a successful bid actually resulted in any of various types of actions.

According to various embodiments, historical information may be collected from past actions taken within the advertising campaign management system. Alternately, or additionally, historical information may be provided to the advertising campaign management system from the RTB exchange. For instance, the RTB may indicate which successful bids resulted in a click, conversion, and/or other type of action.

At 706, a bid value ratio of paid bid value to submitted bid value is determined for each historical bid request. According to various embodiments, the submitted bid value may identify an amount bid for the historical bid request. The paid bid value may identify the actual amount paid for the historical bid request. Since many auctions are conducted using a second price mechanism, the value bid for a successful bid may be higher than the amount actually paid. The bid ratio value may be computed by dividing the paid bid value by the submitted bid value.

At 708, a bucketization of the histogram of the identified bid value ratios is determined. According to various embodiments, determining the bucketization may involve identifying bid value ratio ranges and counting the number of ad requests that fall within each range. Various techniques exist for bucketization. For instance, buckets may be of fixed size or variable size, with size measured either by the number of ad requests within the bucket or the length of the range of the bucket.

At 710, a histogram of the bucketized bid value ratios is created. According to various embodiments, the histogram may be created by estimating a distribution based on the bucketization of the identified bid value ratios determined as discussed with respect to operation 708. An example of a histogram of the bucketized bid value ratios is shown at 902 in FIG. 9.

At 712, a bid quality multiplier is determined based on the created histogram. According to various embodiments, the bid quality multiplier may be any bid ratio value indicated on the created histogram. For instance, the bid quality multiplier may be selected as any ratio that is less than 1. An example of a bid quality multiplier is c′(t) shown at 904 in FIG. 9.

In particular embodiments, the bid quality multiplier may be selected by identifying a value in the bottom few percentile of the histogram. For example, the bid quality multiplier may be selected as the value that designates the first percentile, second percentile, fifth percentile, or other low percentile value from the histogram.

In some implementations, as discussed with respect to operation 512, a bid quality multiplier of less than 1 may result in relatively fewer bids being successful. At the same time, by bidding lower than the estimated value of an advertising request, any successful bids may be expected to have a higher value than if a higher bid had been used. For instance, if a bid for an advertising opportunity request is successful with a bid value that is significantly lower than the estimated value of the advertising opportunity, then the expected value of the advertising opportunity is relatively high.

It should be noted that the operations presented in FIGS. 5-7 may be performed in an order that is different than that shown. Alternately, or additionally, some operations may be omitted or performed with a frequency that is different than that of other operations. For instance, a histogram may be computed less frequently, such as once per day, while a multiplier may be computed more frequently, such as once every few minutes.

FIG. 10 illustrates an example of a bid price determination method 1000, performed in accordance with one or more embodiments. The method 1000 may be used to determine a price to bid on an ad request received during a designated time period. A base bid price may be determined for the ad request based on an estimated performance metric. Then, the bid price may be adjusted based on a bid multiplier.

At 1002, a request is received to determine a bid price for an advertising opportunity bid request received during a designated time period. According to various embodiments, the request may be generated as part of a partially or fully automated system configured to manage advertising bid placement and advertising budget expenditure for one or more advertising campaigns. For instance, the request may be automatically generated for each or selected ones of the suitable advertising opportunity bid requests received during the designated time period. The advertising opportunity bid requests may be received at an advertising campaign management system from a source such as an RTB exchange via a communications interface.

At 1004, an estimated performance metric is determined for the bid request. For instance, the estimated performance metric may be measured as a click through rate (CTR) or an action rate (AR).

Various techniques may be used to estimate CTR or AR. For example, since conversions are rare events, a hierarchical structure of features for each triplet combination of (user, publisher, advertiser) may be used to smooth and impute the AR for advertisements that have a relatively low number of conversion events. As another example, users may be clustered based on their behaviors and interests. Then CTR or AR may be estimated in each user cluster. As yet another example, a machine learning method (e.g., logistic regression) and collaborative filtering technique may be used to combine multiple CTR or AR estimates from different levels in a hierarchy or different user clusters to produce an estimate.

For instance, if the triplet approach is used, then each advertisement may be treated as a leave in an advertiser tree hierarchy. The hierarchy may start with a root and continue layer by layer by classification such as advertiser category, advertiser, insertion order, package, line item, ad and advertisement. Using the historical data, an AR or CTR may be assigned to each node in the tree by aggregating total number of impressions and actions of their children as a raw estimate. Similar hierarchy and raw estimations may be determined for other dimensions, such as those corresponding to publishers and users.

According to various embodiments, after constructing all three hierarchies with initial raw estimates, a smoothing algorithm may be used to adjust the raw estimates on different levels based on factures such as the similarity and closeness of (user, publisher, advertiser) triplet on the hierarchy trees. Then, for each triplet on the leaves of the trees, a logistic regression over the path from that leaf to the root may be applied to determine the estimated performance metric for the leaf triplet.

At 1006, a base bid price is determined for the bid request based on the estimated performance metric. According to various embodiments, the base bid price may be determined in various ways. For example, the base bid price may be determined at least in part based on a performance goal such as cost per action (CPA) or cost per click (CPC). For instance, a performance goal may be specified by an advertiser or designated by an advertising campaign management system administrator. In particular embodiments, the base bid price may be determined by multiplying the performance metric by the performance goal.

In particular embodiments, the base bid price may be determined based on historical data. For example, a median of bid prices in a histogram built using historical data of previous bids may be used as a base bid price. As another example, historical data may be averaged over a group of advertisers who target similar audiences.

At 1008, a bid multiplier is identified for the designated time period. According to various embodiments, the bid multiplier may be determined as described with respect to FIGS. 5-9. For instance, the bid multiplier may be a value less than one, equal to one, or greater than one.

At 1010, a bid price is determined based on the base bid price and the bid multiplier. According to various embodiments, the bid price may be determined by adjusting the base bid price by the bid multiplier. For example, the base bid price may be multiplied by the bid multiplier to determine the bid price. As another example, the bid multiplier may instead take the form of a scaling factor by which the base bid price is divided to determine the bid price. Various mathematical techniques may be used for modifying the base bid price based on the bid multiplier.

At 1012, a bid is placed on the bid request with the determined bid price. According to various embodiments, placing a bid may involve transmitting a message identifying the bid. For instance, the message may be transmitted to a bid exchange from which the bid request originated. The message may identify the request on which the bid is placed and the value of the bid.

Although many of the components and processes are described above in the singular for convenience, it will be appreciated by one of skill in the art that multiple components and repeated processes can also be used to practice the techniques of the present invention.

While the invention has been particularly shown and described with reference to specific embodiments thereof, it will be understood by those skilled in the art that changes in the form and details of the disclosed embodiments may be made without departing from the spirit or scope of the invention. It is therefore intended that the invention be interpreted to include all variations and equivalents that fall within the true spirit and scope of the present invention.

What is claimed is:

1. A method comprising:
determining, via a processor, a base bid price for an advertising opportunity bid request received at a communications interface during a designated time period;
determining, via the processor, a designated bid price for the advertising opportunity bid request, the designated bid price being determined at least in part by applying a bid multiplier value to the base bid price, the bid multiplier value reflecting a target pacing rate associated with the designated time period; and
transmitting a bid placement message via the communications interface, the bid placement message identifying the advertising opportunity bid request and the designated bid price.

2. The method recited in claim 1, the method further comprising:
determining the bid multiplier value by comparing the target pacing rate to a critical pacing rate range.

3. The method recited in claim 2,
wherein the bid multiplier value is less than one when it is determined that the target pacing rate is below the critical pacing rate range.

4. The method recited in claim 3,
wherein the bid multiplier value is determined based on a target bid value ratio, the target bid value ratio identifying a ratio of paid bid value to submitted bid value, the target bid value ratio being determined based on bid request metric values for past advertising opportunity bid requests.

5. The method recited in claim 2,
wherein the bid multiplier value is greater than one when it is determined that the target pacing rate is above the critical pacing rate range.

6. The method recited in claim 5,
wherein the bid multiplier value is determined at least in part based on one or more of: an estimated average bid price for advertising opportunity bid requests received during the designated time period, a bid price cap for bids submitted during the designated time period, the target pacing rate, and the critical pacing rate range.

7. The method recited in claim 1, the method further comprising:
determining a representation of a distribution of bid request metric values for past advertising opportunity bid requests, the representation being determined based on a bucketization of the bid request metric values.

8. The method recited in claim 7,
wherein each of the bid request metric values is a value selected from the group consisting of: a paid value for a submitted bid for a past advertising opportunity bid request, and a ratio of a paid value to a submitted value for a past advertising opportunity bid request.

9. The method recited in claim 1,
wherein the base bid price is determined by multiplying an estimated performance metric for the advertising opportunity bid request by a target performance goal for an advertising campaign, and wherein the estimated performance metric is a performance metric selected from the group consisting of: an action rate and a click through rate.

10. The method recited in claim 1,
wherein the designated bid price is determined by multiplying the base bid price by the bid multiplier value.

11. The method recited in claim 1,
wherein the target pacing rate identifies a desired proportion of purchased advertising opportunity bid requests to received advertising opportunity bid requests during the designated time period.

12. A system comprising:
memory operable to store a base bid price for an advertising opportunity bid request received during a designated time period;
a processor operable to determine a designated bid price for the advertising opportunity bid request, the designated bid price being determined at least in part by applying a bid multiplier value to the base bid price, the bid multiplier value reflecting a target pacing rate associated with the designated time period; and
a communications interface operable to transmit a bid placement message identifying the advertising opportunity bid request and the designated bid price.

13. The system recited in claim 12, wherein the processor is further operable to:
determine the bid multiplier value by comparing the target pacing rate to a critical pacing rate range.

14. The system recited in claim 13,
wherein the bid multiplier value is less than one when it is determined that the target pacing rate is below the critical pacing rate range, and wherein the bid multiplier value is determined based on a target bid value ratio, the target bid value ratio identifying a ratio of paid bid value to submitted bid value, the target bid value ratio being determined based on bid request metric values for past advertising opportunity bid requests.

15. The system recited in claim 13,
wherein the bid multiplier value is greater than one when it is determined that the target pacing rate is above the critical pacing rate range, and wherein the bid multiplier value is determined at least in part based on one or more of: an estimated average bid price for advertising opportunity bid requests received during the designated time period, a bid price cap for bids submitted during the designated time period, the target pacing rate, and the critical pacing rate range.

16. The system recited in claim 12, wherein the processor is further operable to:
determine a representation of a distribution of bid request metric values for past advertising opportunity bid requests, the representation being determined based on a bucketization of the bid request metric values, wherein each of the bid request metric values is a value selected from the group consisting of: a paid value for a submitted bid for a past advertising opportunity bid request, and a ratio of a paid value to a submitted value for a past advertising opportunity bid request.

17. The system recited in claim 12,
wherein the base bid price is determined by multiplying an estimated performance metric for the advertising opportunity bid request by a target performance goal for an advertising campaign, and wherein the estimated performance metric is a performance metric selected from the group consisting of: an action rate and a click through rate.

18. The system recited in claim 12, wherein the processor is further operable to:
determine a representation of a distribution of bid request metric values for past advertising opportunity bid requests, the representation being determined based on a bucketization of the bid request metric values.

19. One or more computer readable media having instructions stored thereon for performing a method, the method comprising:
determining, via a processor, a base bid price for an advertising opportunity bid request received at a communications interface during a designated time period;
determining, via the processor, a designated bid price for the advertising opportunity bid request, the designated bid price being determined at least in part by applying a bid multiplier value to the base bid price, the bid multiplier value reflecting a target pacing rate associated with the designated time period; and
transmitting a bid placement message via the communications interface, the bid placement message identifying the advertising opportunity bid request and the designated bid price.

20. The one or more computer readable media recited in claim 19, the method further comprising:
determining the bid multiplier value by comparing the target pacing rate to a critical pacing rate range.
